(19) United States
(12) Patent Application Publication
(10) Pub. No.: US 2005/0251847 A1
(43) Pub. Date: Nov. 10, 2005

(54) MULTIMEDIA PLAYBACK DEVICE AND DRIVING METHOD THEREOF

(76) Inventors: Chih-Wei Teng, Taipei City (TW); Chih-Chiang Shen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/908,276

(22) Filed: May 5, 2005

(30) Foreign Application Priority Data
May 6, 2004 (TW) 093112753

(51) Int. Cl. H04N 7/173; G06F 17/24; G06F 17/00; G06F 17/21

(52) U.S. Cl. 725/134; 725/142; 725/100; 348/725

(57) ABSTRACT

A multimedia playback device includes a memory module for recording a plurality of sets of first image data, a merging module electrically connected to the memory module for merging the sets of first image data to produce second image data, and a playback module electrically connected to the merging module for driving a display device according to the second image data to simultaneously display images in a display area corresponding to the sets of first image data.

### BACKGROUND OF INVENTION

1. Field of the Invention

The invention relates to a multimedia playback device, and more particularly, to a multimedia playback device and a driving method capable of simultaneously playing a plurality of images.

2. Description of the Prior Art

As multimedia technology advances and user requirements increase, many companies are designing different multimedia processing devices and software such as multimedia playback devices capable of recording television programs received from a remote station. Using these devices, when a user wants to watch an already recorded television program, the user can start the multimedia playback device and watch the already recorded television program. However, according to the prior art, the recorded television program must be stored on a storage medium. Furthermore, each storage medium typically has a limited capacity, which results in the user only being able to store up to a fixed amount of audio/visual data. If more data needs to be stored, the storage medium must be exchanged for another having empty space. Similarly, when the user plays and watches already recorded audio/visual data, the user is only able to continuously watch the fixed amount of audio/visual data. If it is required to watch more than this fixed amount of audio/visual data, the user must repeatedly change the storage medium. Additionally, it is not possible to simultaneously watch multiple sets of already recorded audio/visual data.

### SUMMARY OF INVENTION

One objective of the claimed invention is therefore to provide a multimedia playback device and driving method capable of simultaneously display multiple images, to solve the above-mentioned problems.

According to an exemplary embodiment of the claimed invention, a multimedia playback device is disclosed comprising a memory module for recording a plurality of sets of first image data; a merging module electrically connected to the memory module for merging the sets of first image data to produce second image data; and a playback module electrically connected to the merging module for driving a display device according to the second image data to simultaneously display images in a display area corresponding to the sets of first image data.

According to another exemplary embodiment of the claimed invention, a multimedia playback method is disclosed comprising recording a plurality of sets of first image data; merging the sets of first image data to produce second image data; and driving a display device according to the second image data to simultaneously display images corresponding to the sets of first image data.

According to another exemplary embodiment of the claimed invention, a multimedia playback system is disclosed comprising a memory module for recording a plurality of sets of first image data; a merging module electrically connected to the memory module for merging the sets of first image data to produce second image data; a display device; and a playback module electrically connected to the merging module for driving a display device according to the second image data to simultaneously display images in a display area corresponding to the sets of first image data.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a multimedia playback system according to the present invention.

FIG. 2 is an operational flowchart describing the operations of the multimedia playback system shown in FIG. 1.

FIG. 3 is a block diagram of data flow through the multimedia playback device of FIG. 1 during image data merging.

### DETAILED DESCRIPTION

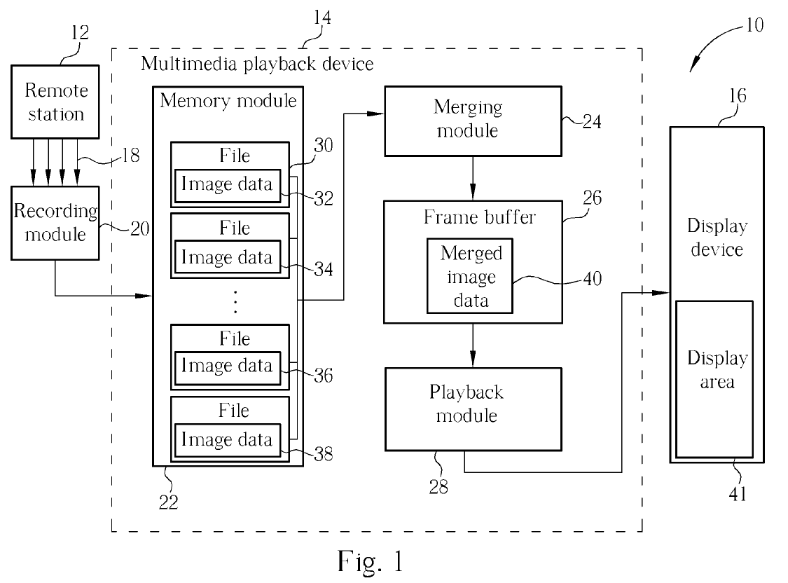

Please refer to FIG. 1. FIG. 1 shows a block diagram of a multimedia playback system 10 according to the present invention. The multimedia playback system 10 includes a remote station 12, a multi-channel playback device 14, and a display device 16. The multi-channel playback device 14 includes a recording module 20, a memory module 22, a merging module 24, a frame buffer 26, and a playback module 28. The multi-channel playback device 14 is connected to the remote station 12 via a plurality of transmission channels 18. In other words, the remote station 12 can separately transmit a plurality of sets of image data 32, 34, 36, 38 to the multi-channel playback device 14 using the plurality of transmission channels 18. For example, the multi-channel playback device 14 could be connected to the remote station 12 using wired or wireless transmission channels 18, where each of the transmission channels 18 corresponds to a designated television frequency channel. The recording module 20 is used to receive and process the multiple sets of image data 32, 34, 36, 38, and record these sets of image data 32, 34, 36, 38 into the memory module 22. In this embodiment, the memory module 22 is a non-volatile storage device (for example a hard drive) used to store the sets of image data 32, 34, 36, 38 as separate files 30. The merging module 24 is electrically connected to the memory module 22 and is used to merge the sets of image data 32, 34, 36, 38 to form merged imaged data 40, which is then stored in the frame buffer 26. Additionally, the playback module 28 is electrically connected to the frame buffer 26 and the display device 16. The playback module 28 drives the display device 16 according to the merged image 40 data stored in the frame buffer 26. That is, in a display area 41, the display device 16 simultaneously plays images corresponding to the multiple sets of image data 32, 34, 36, 38.

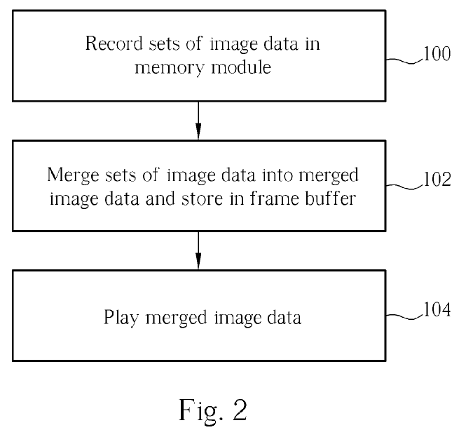

Please refer to FIG. 2. FIG. 2 shows an operational flowchart describing the operations of the multimedia playback system 10. The operational flowchart for the multimedia playback system 10 includes the following steps:

Step 100: The recording module 20 receives and records the plurality of image data sets 32, 34,36, 38. The sets of image data 32, 34,36, 38 are stored separately in corresponding files 30 in the memory module 22.

Step 104: The merging module 24 merges the sets of image data 32, 34,36, 38 stored in the memory module 22 into merged image data 40. The merged image data 40 is then stored in the frame buffer 26.

Step 106: The playback module 28 drives the display device 16 according to the merged image data 40 stored in the frame buffer 26 to simultaneously display images corresponding to the sets of image data 32, 34, 36, 38.

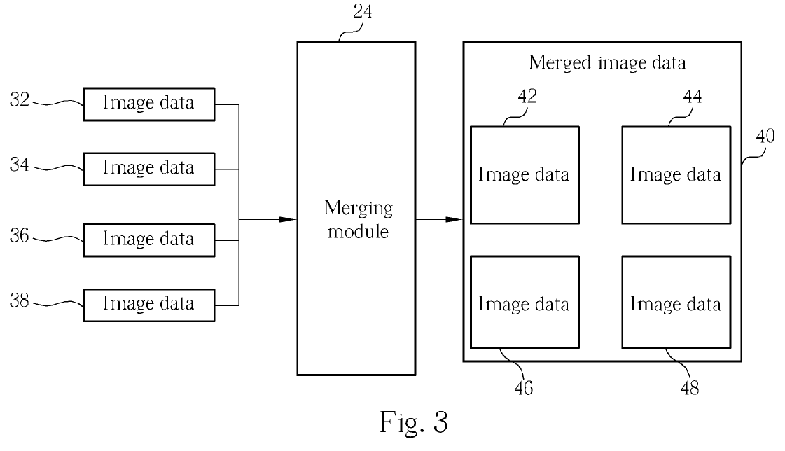

As shown above, an important aspect of the multi-channel playback device 14 involves producing the desired merged image data 40 in the merging module 24. As such, please refer to FIG. 3. FIG. 3 shows a block diagram of data flow through the multi-channel playback device 14 during image data merging. In the following, assume the sets of image data 32, 34, 36, 38 are each originally configured to drive the display device 16 to display a corresponding image at a prearranged resolution (for example 640×480). When the merging module 24 merges the sets of image data 32, 34, 36, 38 stored in the memory module 22 into the merged image data 40, if the display area of the display device 16 is fixed according to the prearranged resolution, then the merged image data 40 must still correspond to the prearranged resolution in order to accurately drive the display device 16. Because of this, in this embodiment, the merging module 24 will perform an adjustment on the original resolutions of the sets of image data 32, 34,36,38 such that the merged image data 40 complies with the prearranged resolution and can be used to drive the display device 16 to output a image corresponding to the sets of image data 32, 34,36,38. As shown in FIG. 3, the merging module 24 converts the sets of image data 32, 34, 36, 38 to become corresponding sets of image data 42, 44, 46, 48. For example, assume each set of image data 32, 34, 36, 38 corresponds to 640×480 resolution. Because of this, the merging module 24 adjusts the pixels in the image data sets 32, 34, 36,38 to perform a resolution adjustment operation. In other words, when the merging module 24 is producing the merged image data 40, it ensures each corresponding set of image data 42, 44, 46, 48 has 320×240 resolution. Therefore, the merged image data 40 is at a resolution of 640×480 and when the playing module 28 drives the display device 16 according to the merged image data 40, the display area 41 of the display device will divided into four partitions. Each partition is driven by a corresponding set of image data 42, 44, 46, 48. Because of this, in the same display area 41, the four image partitions are used to allow the display of the multiple sets of image data 32, 34, 36, 38.

The present invention of multimedia playback device and driving method record a plurality of image data sets in a memory module and them merge the multiple sets of image data into merged image data to drive a display device and simultaneously play images corresponding to the sets of image data. Because the recorded image data is received from different program channels, the merged image data produced in the merging module can be used to simultaneously drive the display device to display content from the different program channels. In modern society, people's lives are very busy and often do not include very much time to watch recorded television programs. The present invention of multimedia playback device and driving method therefore allow a display device to simultaneously display multiple television programs. This saves television watching and recording time otherwise wasted by the prior art.

Those skilled in the art will readily observe that numerous modifications and alterations of the device may be made while retaining the teachings of the invention. Accordingly, the above disclosure should be construed as limited only by the metes and bounds of the appended claims.

1. A multimedia playback device comprising:
a memory module for recording a plurality of sets of first image data;
a merging module electrically connected to the memory module for merging the sets of first image data to produce second image data; and
a playback module electrically connected to the merging module for driving a display device according to the second image data to simultaneously display images in a display area corresponding to the sets of first image data.

2. The multimedia playback device of claim 1, further comprising a recording module electrically connected to the memory module and a remote station for producing the plurality of sets of first image data according to image data transmitted by the remote station, and for inputting the plurality of sets of first image data into the memory module.

3. The multimedia playback device of claim 2, wherein the recording module receives the image data transmitted by the remote station from a plurality of transmission channels.

4. The multimedia playback device of claim 3, wherein each of the sets of first image data corresponds to one of the transmission channels.

5. The multimedia playback device of claim 1, wherein the memory module is a non-volatile storage device.

6. The multimedia playback device of claim 5, wherein the non-volatile storage device is a hard drive.

7. The multimedia playback device of claim 1, further comprising a frame buffer electrically connected to the playback module and the merging module for storing the second image data.

8. The multimedia playback device of claim 1, wherein the sets of first image data and the second image data have the same corresponding picture resolution.

9. A multimedia playback method comprising:
recording a plurality of sets of first image data;
merging the sets of first image data to produce second image data; and
driving a display device according to the second image data to simultaneously display images corresponding to the sets of first image data.

10. The multimedia playback method of claim 9, further comprising producing the sets of first image data according to image data transmitted by a remote station.

11. The multimedia playback method of claim 10, wherein producing the sets of first image data further comprises receiving the image data transmitted by the remote station from a plurality of transmission channels.

12. The multimedia playback method of claim 11, wherein each of the sets of first image data corresponds to one of the plurality of transmission channels.

13. The multimedia playback method of claim 9, wherein the sets of first image data and the second image data have the same corresponding picture resolution.

14. A multimedia playback system comprising:
a memory module for recording a plurality of sets of first image data;
a merging module electrically connected to the memory module for merging the sets of first image data to produce second image data;
a display device; and
a playback module electrically connected to the merging module for driving the display device according to the second image data to simultaneously display images in a display area corresponding to the sets of first image data.

15. The multi-media playback system of claim 14, further comprising a recording module electrically connected to the memory module and a remote station for producing the sets of first image data according to image data transmitted by the remote station; and for inputting the sets of first image data into the memory module.

16. The multimedia playback system of claim 15, wherein the recording module receives the image data transmitted by the remote station from a plurality of transmission channels.

17. The multimedia playback system of claim 16, wherein each of the sets of first image data corresponds to one of the transmission channels.

18. The multimedia playback device of claim 14, further comprising a frame buffer electrically connected to the playback module and the merging module for storing the second image data.

19. The multimedia playback device of claim 14, wherein the sets of first image data and the second image data have the same corresponding picture resolution.
